(19) United States
(12) Patent Application Publication
(10) Pub. No.: US 2023/0250007 A1
(43) Pub. Date: Aug. 10, 2023

(54) COOLING SYSTEM AND METHODS FOR GLASS FORMING ROLLS

(71) Applicant: CORNING INCORPORATED, CORNING, NY (US)

(72) Inventors: ALLAN MARK FREDHOLM, Vulaines sur Seine (FR); VINCENT GUILLARD, Chevrainvilliers (FR); YIFEI WANG, Avon (FR)

(21) Appl. No.: 18/015,557

(22) PCT Filed: Jul. 1, 2021
(86) PCT No.: PCT/US2021/040080

§ 371 Date: Jan. 11, 2023

Related U.S. Application Data
(60) Provisional application No. 63/052,658, filed on Jul. 16, 2020.

(51) Int. Cl. C03B 17/06; C03B 35/18

(52) U.S. Cl. CPC C03B 17/06; C03B 35/184

(57) ABSTRACT

Apparatuses and methods are described for cooling glass forming rolls during the glass manufacturing process. The apparatus and methods mix a liquid, such as water, and a gas, such as air, to form a liquid and gas mixture that is provided to an inside surface of the glass forming rolls to dissipate heat. In some examples, the apparatus and methods control the amount of liquid and air provided to the glass forming roll based on detecting temperatures of the glass forming rolls. In some examples, a computing device automatically controls the amount of liquid and gas mixture provided to the glass forming rolls, and may further control the proportions of each of the liquid and gas to be mixed. The apparatus and methods may allow for a more consistent glass thickness across the glass sheet, as well as a reduction in glass sheet defects.

### CROSS-REFERENCE TO RELATED APPLICATIONS

This application is a national stage entry of International Patent Application Serial No. PCT/US2021/040080 filed on Jul. 1, 2021, which in turn, claims the benefit of priority under 35 U.S.C. § 119 of U.S. Provisional Application Ser. No. 63/052,658 filed on Jul. 16, 2020, the contents of each of which are relied upon and incorporated herein by reference in their entireties.

### BACKGROUND

### Field of the Disclosure

The present disclosure relates to the production of glass sheets and, more particularly, to apparatus and methods for cooling fusion rolls during glass sheet production.

### Background

Glass sheets are used in a variety of applications. For example, they may be used in glass display panels such as in mobile devices, laptops, tablets, computer monitors, and television displays. Glass sheets may be manufactured by a fusion drawdown process whereby one or more glass forming rolls draw molten glass over a glass forming apparatus. For a variety of applications, the close control of the thickness of manufactured glass can be important. As glass forming rolls draw down molten glass, they heat up. As a result, portions of molten glass contacting or even near the glass forming rolls may not cool down as quickly as other portions of the molten glass. This uneven cooling across the entirety or portions of a width of molten glass may cause defects, such as wavy surfaces, cracks, or thickness variations in the manufactured glass.

In an attempt to dissipate heat from the glass forming rolls, some systems attempt to cool the glass forming rolls by flowing air or water along an internal diameter of the glass forming rolls. These systems, however, may cause too little, or too much, heat to be dissipated from the glass forming rolls. As such, there are opportunities to improve the production of glass sheets.

### SUMMARY

Apparatuses and methods disclosed herein allow for cooling glass forming rolls during the glass manufacturing process. The apparatus and methods may mix a liquid, such as water, and a gas, such as air, to form a liquid and gas mixture that is provided to an inside surface of the glass forming rolls to dissipate heat. In some examples, the apparatus and methods control the amount of liquid and air provided to the glass forming roll based on detecting temperatures of the glass forming rolls. In some examples, a computing device automatically controls the amount of liquid and gas mixture provided to the glass forming rolls, and may further control the proportions of each of the liquid and gas to be mixed. The apparatus and methods may allow for a more consistent glass thickness across the glass sheet, as well as a reduction in glass sheet defects

In some embodiments, an apparatus includes a first passageway configured to provide a gas, and a second passageway in fluid communication with the first passageway and configured to provide a liquid. The apparatus further includes a junction configured to mix the gas from the first passageway with the liquid from the second passageway to generate a gas-liquid mixture. The apparatus also includes a conduit in fluid communication with the junction and configured to disperse the gas-liquid mixture to a glass forming roll.

In some examples, the conduit is at least partially located within a cavity of the glass forming roll. In some examples, the conduit comprises a plurality of openings. In some examples, the gas-liquid mixture is dispersed through the plurality of openings in the conduit to contact at least a portion of an inside surface of a cavity of the glass forming roll.

In some examples, the apparatus includes a controller communicatively coupled to a temperature sensor, where the temperature sensor is configured to detect a temperature of the glass forming roll. In addition, the controller is configured to receive the temperature of the glass forming roll from the temperature sensor.

In some examples, the apparatus includes a gas flow control communicatively coupled to the controller, where the airflow control is configured to adjust a flow (e.g., flow rate) of the gas within the first passageway. In some examples, the controller is configured to provide a signal to the gas flow control to adjust the flow of the gas.

In some examples, the apparatus includes a liquid flow control communicatively coupled to the controller, where the liquid flow control is configured to adjust a flow (e.g., flow rate) of the liquid within the second passageway. In some examples, the controller is configured to provide a signal to the liquid flow control to adjust the flow of the liquid.

In some embodiments, an apparatus includes a memory device that stores instructions, and a controller that includes at least one processor communicatively coupled to the memory device. The at least one process is configured to execute the instructions, causing the controller to perform operations that include transmitting a first signal to cause a flow of a air at a first air volume flow rate within a first passageway. The operations also include transmitting a second signal to cause a flow of water at a first water volume flow rate within a second passageway. The flow of air is mixed with the flow of water at a junction to form an air-water mixture, and the air-water mixture is dispersed to cool a glass forming roll.

In some examples, the operations include receiving a temperature from a temperature sensor configured to detect temperatures of the glass forming roll. The operations may also include adjusting the flow of water to be at a second water volume flow rate based on the temperature.

In some embodiments, a method of cooling a glass forming roll includes flowing air through a first passageway, and flowing water through a second passageway in fluid communication with the first passageway. The method also includes mixing the air from the first passageway with the water from the second passageway at a junction to form an air-water mixture. The method further includes dispersing the air-water mixture to a glass forming roll.

In some examples, the method includes dispersing the air-water mixture within a cavity of the glass forming roll.

In some examples, the method includes receiving a temperature of the glass forming roll, and adjusting a flow rate of the water flowing through the second passageway based on the temperature.

In some examples, the method includes receiving a temperature of the glass forming roll, and adjusting a flow rate of the air flowing through the first passageway based on the temperature.

### BRIEF DESCRIPTION OF DRAWINGS

The above summary and the below detailed description of illustrative embodiments may be read in conjunction with the appended Figures. The Figures show some of the illustrative embodiments discussed herein. As further explained below, the claims are not limited to the illustrative embodiments. For clarity and ease of reading, Figures may omit views of certain features.

FIG. 1 schematically illustrates an exemplary glass forming apparatus with a glass forming roll cooling system in accordance with some examples.

FIG. 2 is a block diagram of an exemplary glass forming roll cooling control system in accordance with some examples.

FIG. 3 illustrates portions of an exemplary glass forming roll cooling system in accordance with some examples.

FIG. 4 illustrates portions of another exemplary glass forming roll cooling system in accordance with some examples.

FIG. 5 illustrates portions of yet another exemplary glass forming roll cooling system in accordance with some examples.

FIG. 6 illustrates an exemplary method that may be carried out by a glass forming roll cooling system in accordance with some examples.

FIG. 7 illustrates another exemplary method that may be carried out by a glass forming roll cooling system in accordance with some examples.

FIG. 8 illustrates yet another exemplary method that may be carried out by a glass forming roll cooling system in accordance with some examples.

### DETAILED DESCRIPTION

The present application discloses illustrative (i.e., example) embodiments. The disclosure is not limited to the illustrative embodiments. Therefore, many implementations of the claims will be different than the illustrative embodiments. Various modifications can be made to the claims without departing from the spirit and scope of the disclosure. The claims are intended to cover implementations with such modifications.

At times, the present application may use directional terms (e.g., front, back, top, bottom, left, right, etc.) to give the reader context when viewing the Figures. The claims, however, are not limited to the orientations shown in the Figures. Any absolute term (e.g., high, low, etc.) can be understood as disclosing a corresponding relative term (e.g., higher, lower, etc.).

The present disclosure presents apparatus and methods to cool glass forming rolls in glass forming systems during the formation of glass. The embodiments may use a combination of a liquid, such as water, and a gas, such as air, to dissipate heat from one or more glass forming rolls. The embodiments may further allow for the automatic control of heat dissipation from the glass forming rolls based on the application of the liquid and air to portions of the glass forming rolls.

In some examples, the gas may be nitrogen, helium, or any other suitable gas, and the liquid may be a glycol/water mixture, a refrigerant, deionized water, or any other suitable liquid.

Among other advantages, the embodiments may allow for a more even cooling across the entirety or portions of a width of molten glass thereby reducing the chances of the glass forming with defects, such as wavy surfaces, cracks, or thickness variations. For example, the embodiments may allow for the manufacturer of glass with reduced defects compared to glass manufactured with conventions glass forming systems. Those of ordinary skill in the art having the benefit of these disclosures may recognize other benefits as well.

In some examples, a glass forming system includes one or more glass forming rolls that draw molten glass over a glass forming apparatus. The glass forming system further includes a glass forming roll cooling system that can dissipate heat from each of the glass forming rolls based on a water and air mixture. For example, the glass forming roll cooling system may mix water and air, and provide the combined water and air mixture to an inside surface of each of the glass forming rolls. The water and air mixture may dissipate heat from the glass forming rolls, and the mixture may then be routed away from the glass forming rolls.

In some examples, the glass forming roll cooling system controls an amount of air pressure, and a flow of water, that are combined to form the air and water mixture for cooling the glass forming rolls. For example, the glass forming roll cooling system may include one or more air pressure gauges and/or air control valves to control the flow of air, and one or more water flow meters and/or water flow valves to control the flow of water.

In some examples, the amount of air pressure and flow of water is configured by a user (e.g., an operator of the glass forming roll cooling system). In some examples, the glass forming roll cooling system automatically determines one or more of the amount of air pressure and flow of water based on a detected temperature of the glass forming rolls. For example, the glass forming roll cooling system may receive one or more temperatures of each glass forming roll during the drawdown of molten glass. Based on the detected temperature, the glass forming roll cooling system configures one or more of the air pressure gauges to provide an amount of air.

For example, the glass forming roll cooling system may increase an amount of air provided to a glass forming roll (e.g., by causing the air pressure gauge to increase air pressure) when the detected temperature is above a temperature range. If, however, the detected temperature is below the temperature range, the glass forming roll cooling system may decrease the amount of air (e.g., by causing the air pressure gauge to reduce air pressure).

Similarly, the glass forming roll cooling system may increase an amount of water flow provided to a glass forming roll when the detected temperature is above a temperature range (e.g., by causing a water valve to further open). If, however, the detected temperature is below the temperature range, the glass forming roll cooling system may decrease the amount of water flow (e.g., by causing the water valve to further close).

In some examples, the amount of air and/or water provided to each glass forming roll is determined based on execution of one or more algorithms, such as a machine learning model. For example, the algorithm may determine whether to adjust the amount of air based on one or more of a detected temperature of a glass forming roll, a type of glass, a (e.g., desired) thickness of the manufactured glass, a current environment (e.g., room) temperature, and the type of material of the glass forming roll, for example.

In some examples, an apparatus includes a first passageway configured to provide a gas, and a second passageway in fluid communication with the first passageway and configured to provide a liquid. In some examples, the gas may be air, oxygen, nitrogen, helium, or any other suitable gas, and the liquid may be water, a glycol/water mixture, a refrigerant, deionized water, or any other suitable liquid.

The apparatus also includes a junction configured to mix the gas from the first passageway with the liquid from the second passageway to generate a gas-liquid mixture. The apparatus further includes a nozzle in fluid communication with the junction and configured to disperse the gas-liquid mixture to a glass forming roll.

In some examples, the nozzle is at least partially located within a cavity of the glass forming roll. In some examples, the nozzle includes a plurality of openings. In some examples, the gas-liquid mixture is dispersed through the plurality of openings causing the gas-liquid mixture to contact at least a portion of an inside surface of the cavity of the glass forming roll.

In some examples, the apparatus includes a controller communicatively coupled to a temperature sensor, where the temperature sensor is configured to detect a temperature of the glass forming roll, and where the controller is configured to receive the temperature of the glass forming roll from the temperature sensor.

In some examples, the apparatus includes a gas flow control communicatively coupled to the controller and configured to adjust a flow (e.g., flow rate) of the gas within the first passageway. In some examples, the controller is configured to provide a signal to the airflow control to adjust the flow of the gas.

In some examples, the apparatus includes a liquid flow control communicatively coupled to the controller and configured to adjust a flow (e.g., flow rate) of the liquid within the second passageway. In some examples, the controller is configured to provide a signal to the liquid flow control to adjust the flow of the liquid.

In some examples, providing the second signal to the liquid flow control includes determining that the temperature of the glass forming roll is not within a temperature range, wherein the temperature range comprises a maximum temperature and a minimum temperature. In addition, for the condition where the temperature of the glass forming roll is above the maximum temperature, the controller is configured to provide the second signal to the liquid flow control to increase the flow of the liquid. Otherwise, for the condition where the temperature of the glass forming roll is below the minimum temperature, the controller is configured to provide the second signal to the liquid flow control to decrease the flow of the liquid.

In some examples, the apparatus includes a gas pressure gauge configured to measure gas pressure of the gas in the first passageway. In some examples, the apparatus includes a controller communicatively coupled to the gas pressure gauge. The controller is configured to receive, from the gas pressure gauge, data identifying the gas pressure of the air in the first passage way.

In some examples, the apparatus includes a liquid flow meter configured to measure a flow rate of the liquid in the second passageway. In some examples, the apparatus includes a controller communicatively coupled to the liquid flow meter. The controller is configured to receive, from the flow meter, data identifying the flow rate of the liquid in the second passageway.

In some examples, an apparatus includes a memory device storing instructions, and a controller comprising at least one processor communicatively coupled to the memory device. The at least one processor is configured to execute the instructions, causing the controller to transmit a first signal to cause a flow of air at a first air volume flow rate within a first passageway, and to transmit a second signal to cause a flow of water at a first water volume flow rate within a second passageway. The flow of air is mixed with the flow of water at a junction to form an air-water mixture, and the air-water mixture is dispersed to cool a glass forming roll. Although described with respect to air and water, any suitable gas, and any suitable liquid, may be substituted for the air and water, respectively.

In some examples, the controller is configured to transmit a third signal to a temperature sensor configured to detect a temperature of the glass forming roll, and receive, in response to transmitting the third signal, a temperature from the temperature sensor. The controller is also configured to adjust the flow of water to be at a second water volume flow rate based on the temperature.

In some examples, adjusting the flow of water includes determining that the temperature is outside a temperature range, and increasing the flow water to be at the second water volume flow rate based on the determination.

In some examples, adjusting the flow of water includes determining the second water volume flow rate based on a table associating each of a plurality of temperature ranges with a water volume flow rate range.

In some examples, adjusting the flow of water includes executing a machine learning algorithm to determine the second water volume flow rate.

In some examples, the controller is configured to receive, from an air pressure gauge, a first pressure of air within the first passageway, where the controller is configured to cause the flow of water at the first water volume flow rate based on the first pressure of air.

In some examples, the controller is configured to receive, from a flow meter, the first water volume flow rate.

In some examples, a method to provide cooling to a glass forming roll includes providing air via a first passageway, and providing water via a second passageway that is in fluid communication with the first passageway. The method also includes mixing the air from the first passageway with the water from the second passageway at a junction to generate an air-water mixture. The method further includes dispersing the air-water mixture to a glass forming roll. Although described with respect to air and water, any suitable gas, and any suitable liquid, may be substituted for the air and water, respectively.

In some examples, the method includes drawing molten glass with the glass forming roll from a forming apparatus, where the dispersing of the air-water mixture is performed during the drawing of the molten glass.

In some examples, the method includes receiving a temperature of the glass forming roll, and adjusting a flow rate of the water provided via the second passageway based on the temperature.

In some examples, the method includes receiving a temperature of the glass forming roll, and adjusting a flow rate of the air provided via the first passageway based on the temperature.

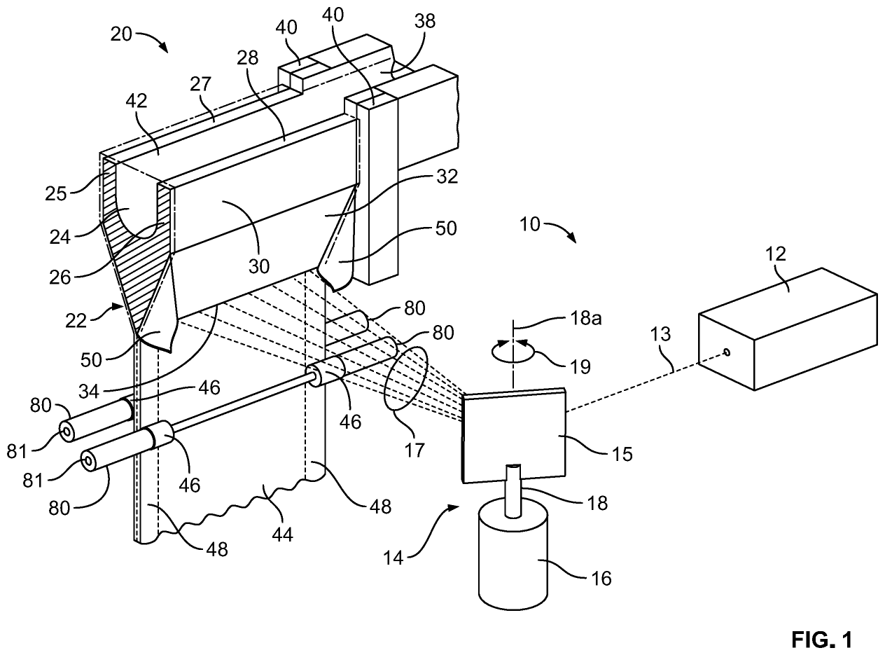

Referring to FIG. 1, glass forming apparatus 20 includes a forming wedge 22 with an open channel 24 that is bounded on its longitudinal sides by walls 25 and 26. The walls 25 and 26 terminate at their upper extent in opposed longitudinally extending overflow weirs 27 and 28, respectively. The overflow weirs 27 and 28 are integral with a pair of opposed and substantially vertical forming surfaces 30 that, in turn, are integral with a pair of opposed downwardly inclined converging forming surfaces 32. The pair of downwardly inclined converging surfaces 32 terminate at a substantially horizontal lower apex that comprises a root 34 of the forming wedge 22. Each of the downwardly inclined converging surfaces 32 may include, in some examples, a pair of edge directors 50.

Molten glass is delivered into open channel 24 by means of a delivery passage 38 that is in fluid communication with the open channel 24. A pair of dams 40 are provided above overflow weirs 27 and 28 adjacent each end of open channel 24 to direct the overflow of the free surface 42 of molten glass over overflow weirs 27 and 28 as separate flows of molten glass. For convenience, the pair of dams 40 that are located at the end of the open channel 24 that is adjacent the delivery passage 38 are illustrated. The separate flows of molten glass flow down over the pair of opposed substantially vertical forming surfaces 30 and the pair of opposed downwardly inclined converging forming surfaces 32 to the root 34 where the separate flows of molten glass converge to form the glass ribbon 44. Each pair of edge directors 50 keeps molten glass along a respective downwardly inclined converging forming surface 32, until the molten glass reaches the root 34.

Glass forming rolls 46 (e.g., pulling rolls) are located downstream of the root 34 of the forming wedge 22 and engage side edges 48 at both sides of the glass ribbon 44 to apply tension to the glass ribbon 44. The glass forming rolls 46 may be positioned sufficiently below the root 34 that the thickness of the glass ribbon 44 is essentially fixed at that location. The pulling rolls 46 may draw the glass ribbon 44 downwardly at a prescribed rate that establishes the thickness of the glass ribbon as it is formed at the root 34.

Each of the glass forming rolls 46 are operatively coupled (e.g., attached) to a rotary joint 80 that allows for rotation of each of the glass forming rolls 46. Although not illustrated, a rotating speed of each of the rotary joints 80 may controlled by one or more control devices, such as one or more processors. Moreover, each rotary joint 80 may include an inner passageway 81 that allows for an air-water mixture to be provided to an inside surface of each glass forming roll 46. For example, an inner cavity of rotary joint 80 may form passageway 81. Although described with respect to air and water, any suitable gas, and any suitable liquid, may be substituted for the air and water, respectively.

As illustrated and described with respect to other figures below, each passageway 81 may lead to a conduit within each glass forming roll 46 that disperses the air-water mixture through a plurality of openings to the inside surface of each glass forming roll 46. For example, each passageway 81 may comprise a tube that allows for the flow of the air-water mixture. The tube may include a plurality of openings to allow for the spread of the air-water mixture. Each passageway 81 may be at least partially located within a cavity of a glass forming roll 46. For example, a pressure of the air may cause the spread of water into droplets within the cavity of glass forming roll 46.

In some examples, the flow of air and water is controlled by a glass forming roll cooling control system, such as the glass forming roll cooling control system 10 described with respect to FIG. 2. For example, and for each glass forming roll 46, an air pressure gauge and/or air valve may allow for the flow of air into passageway 81, and a water flow meter and/or water valve may allow for the flow of water into passageway 81.

FIG. 1 also illustrates an exemplary laser beam control system 10 that can include a laser generator 12 that is configured to generate and emit a laser beam 13. In an embodiment, the laser beam 13 is directed to molten glass below (e.g., just below) root 34, where the laser beam energy provided by laser beam 13 is uniform at points of incidence across the molten glass. The laser beam 13 can be directed by laser generator 12 to the molten glass via, for example, reflecting apparatus 14. Although one laser generator 12 generating a laser beam 13 to reflecting apparatus 14 is illustrated, in some examples, additional laser beam control system 10 may employ additional laser generators 12 and/or reflecting apparatus 14. For example, laser beam control system 10 may employ a second laser generator 12 to direct a laser beam to the molten glass via reflecting apparatus 14. As another example, laser beam control system 10 may employ a second laser generator 12 to direct a laser beam to the molten glass via a second reflecting apparatus 14.

In an embodiment, reflecting apparatus 14 can include a reflecting surface 15 that is configured to receive the laser beam 13 generated and emitted by the laser generator 12 and reflected onto at least predetermined portions of the molten glass. Reflecting apparatus 14 may be, for example, a mirror configured to deflect a laser beam from laser generator 12. Reflecting apparatus 14 may therefore function as a beam-steering and/or scanning device. In FIG. 1, the laser beam 13 is illustrated as being advanced by reflecting apparatus 14 as reflected laser beams 17 to a plurality of preselected portions of the molten glass.

The reflecting surface 15 in one example can comprise a gold-coated mirror although other types of mirrors may be used in other examples. Gold-coated mirrors may be desirable under certain applications to provide superior and consistent reflectivity relative to infrared lasers, for example. In addition, the reflectivity of gold-coated mirrors is virtually independent of the angle of incidence of laser beam 13 and, therefore, the gold-coated mirrors are particularly useful as scanning or laser beam-steering mirrors.

The reflecting apparatus 14 in the embodiment illustrated in FIG. 1 may also include a regulating mechanism 16 (e.g., a galvanometer or polygon scanner) configured to adjust an attitude of the reflecting surface 15 of the reflecting apparatus 14 relative to the receipt of the laser beam 13 and a location of a preselected portion of an edge director 50. For example, reflecting apparatus 14 can rotate or tilt reflecting surface 15 to direct laser beam 13 to a predetermined portion of an edge director 50 as reflected laser beams 17, for example.

According to one example, the regulating mechanism 16 can comprise a galvanometer that is operatively associated with the reflecting surface 15 so that the reflecting surface 15 can be rotated by the galvanometer along an axis in relation to the glass ribbon 44. For example, the reflecting surface 15 can be mounted on a rotating shaft 18 that is driven by a galvanometer motor and rotated about axis 18a as shown by double arrow 19.

FIG. 2 illustrates portions of an exemplary glass forming roll cooling control system 10 that includes a control computer 52 communicatively coupled to at least one glass forming roll control 55, at least one water flow control 75, at least one airflow control 65, and at least one temperature sensor 85. Control computer 52 can include one or more processors, one or more field-programmable gate arrays (FPGAs), one or more application-specific integrated circuits (ASICs), one or more state machines, digital circuitry, or any other suitable circuitry. In some embodiments, control computer 52 may be implemented in any suitable hardware or hardware and software (e.g., one or more processors executing instructions stored in memory). For example, a non-transitory computer readable medium such as, for example, a read-only memory (ROM), an electrically erasable programmable read-only memory (EEPROM), flash memory, a removable disk, CD-ROM, any non-volatile memory, or any other suitable memory, may store instructions that may be obtained and executed by any one or more processors of control computer 52 to execute one or more of the functions described herein.

Glass forming roll control 55 may control a rotation of a corresponding rotary joint 80 which, in turn, rotates a corresponding glass forming roll 46. For example, glass forming roll control 55 may control the rotational speed (e.g., degrees per second) of rotary joint 80. In some examples, glass forming roll control 55 may be a control unit of a corresponding rotary joint 80.

Water flow control 75 may control a flow of water provided to a passageway 81 of rotary joint 80. For example, water flow control 75 may control a volume flow rate (e.g., liters per minute) of water provided to the passageway 81 via one or more flow valves. In some examples, water flow control 75 may also provide the current volume flow rate of water. For example, water flow control 75 may, in response to one or more signals, provide the volume of water being provided to passageway 81. In some examples, water flow control 75 provides the volume of water detected by a flow meter configured to detect the volume of water proceeding through passageway 81. Although illustrated and described as controlling a flow of water, water flow control 75 may be any suitable liquid flow control that may control the flow of any suitable liquid.

Airflow control 65 may control a flow of air provided to passageway 81 of rotary joint 80. For example, airflow control 65 may control a volume flow rate of air provided to the passageway 81 via one or more airflow control valves. In some examples, airflow control 65 may also provide the current volume flow rate of air. For example, airflow control 75 may, in response to one or more signals, provide the volume of air being provided to passageway 81 of 80 rotary joint 80. In some examples, airflow control 65 provides the volume of air detected by a flow meter configured to detect the volume of air proceeding through passageway 81. Although illustrated and described as controlling a flow of air, airflow control 65 may be any suitable gas flow control that may control the flow of any suitable gas.

In some examples, control computer 52 transmits a signal to glass forming roll control 55 to adjust the rotational speed of a glass forming roll 46. For example, control computer 52 may transmit the signal to increase, or decrease, the rotational speed of the glass forming roll 46.

In some examples control computer 52 transmits a signal to water flow control 75 to adjust a water flow volume, such as a water volume flow rate of water being provided to passageway 81 of rotary joint 80. For example, control computer 52 may transmit the signal to increase, or decrease, a water volume flow rate of water being provided to passageway 81.

In some examples, a user may provide (e.g., via a graphical user interface to control computer 52) a configuration setting value that indicates a water volume flow rate to provide to passageway 81. The configuration setting value may be stored in a non-volatile memory, for example. Control computer 52 may read the configuration setting value, and may determine the water volume flow rate based on the configuration setting value. Control computer 52 may then generate water flow data identifying and characterizing the water volume flow rate, and may transmit the water flow data to water flow control 75 to set the determined water flow volume.

As an example, control computer 52 may determine the water volume flow rate based on a water flow table stored in memory (e.g., non-volatile memory). The water flow table may associate each of a plurality of configuration setting values with a water volume flow rate (or water volume flow rate range). Control computer 52 may determine the water volume flow rate corresponding to one of the plurality of configuration setting values that matches the configuration setting value provided by the user. In some examples, control computer 52 determines the water volume flow rate based on executing an algorithm that translates the configuration setting value to a water volume flow rate.

In some examples, control computer 52 determines the water volume flow rate based on one or more detected temperatures. For example, temperature sensor 85 may be operatively coupled to a glass forming roll 46. Control computer 52 may receive a temperature from the temperature sensor 85 (e.g., in response to a signal), and may determine the water volume flow rate based on the detected temperature. As an example, control computer 52 may determine the water volume flow rate based on a table that associates temperatures to water volume flow rates. The table may be empirically determined, for example.

In some examples, the table associates each of a plurality of temperature ranges with a water volume flow rate range. Control computer 52 may determine the temperature range which the detected temperature falls within, and cause the water volume flow rate to be within the corresponding water volume flow rate range.

As another example, control computer 52 may determine the water volume flow rate based on executing an algorithm that generates the water volume flow rate based on the detected temperature. The algorithm may be a machine learning model that was trained based on features identifying temperatures and water flow volumes. In some examples, the machine learning model is trained with data identifying one or more of glass forming roll 46 temperatures, molten glass type, desired glass thickness of the manufactured glass, a current environment temperature, and a type of material of the glass forming roll 46.

In some examples, control computer 52 transmits a signal to airflow control 65 to adjust a flow of air (e.g., flow rate of the air, air pressure), such as an air volume flow rate being provided to passageway 81 of rotary joint 80. For example, control computer 52 may transmit the signal to increase, or decrease, the air volume flow rate being provided to passageway 81.

In some examples, a user may provide (e.g., via a graphical user interface to control computer 52) a configuration setting value that indicates an air volume flow rate to provide to passageway 81. The configuration setting value may be stored in a non-volatile memory, for example. Control computer 52 may read the configuration setting value, and may determine the air volume flow rate based on the configuration setting value. Control computer 52 may then generate airflow data identifying and characterizing the air volume flow rate, and may transmit the airflow data to airflow control 65 to set the determined air volume flow rate.

As an example, control computer 52 may determine the air volume flow rate based on an airflow table stored in memory (e.g., non-volatile memory). The airflow table may associate each of a plurality of configuration setting values with an air volume flow rate (or air volume flow rate range). Control computer 52 may determine the air volume flow rate corresponding to one of the plurality of configuration setting values that matches the configuration setting value provided by the user. In some examples, control computer 52 determines the air volume flow rate based on executing an algorithm that translates the configuration setting value to an air volume flow rate.

In some examples, control computer 52 determines the air volume flow rate based on one or more detected temperatures. For example, temperature sensor 85 may be operatively coupled to a glass forming roll 46. Control computer 52 may receive a temperature from the temperature sensor 85 (e.g., in response to a signal), and may determine the air volume flow rate based on the detected temperature. As an example, control computer 52 may determine the air volume flow rate based on a table that associates temperatures to airflow volume rates. The table may be empirically determined, for example.

In some examples, the table associates each of a plurality of temperature ranges with an air volume flow rate range. Control computer 52 may determine the temperature range which the detected temperature falls within, and cause the air volume flow rate to be within the corresponding air volume flow rate range.

As another example, control computer 52 may determine the air volume flow rate based on executing an algorithm that generates the airflow volume based on the detected temperature. The algorithm may be a machine learning model that was trained based on features identifying temperatures and airflow volumes. In some examples, the machine learning model is trained with data identifying one or more of glass forming roll 46 temperatures, molten glass type, desired glass thickness of the manufactured glass, a current environment temperature, and a type of material of the glass forming roll 46.

In some examples, control computer 52 determines a water volume flow rate based on a current airflow volume and one or more detected temperatures. For example, control computer 52 may receive a temperature from a temperature sensor 85 coupled to a glass forming roll 46. Control computer 52 may execute an algorithm that generates the water flow volume based on a current airflow (e.g., as currently configured by airflow control 65) and the detected temperature. The algorithm may be a machine learning algorithm trained with supervised data identifying temperatures, airflow volumes, and water flow volumes, for example. Control computer 52 may configure water flow control 75 such that a water flow in accordance with the determined water volume flow rate is provided to a passageway 81.

In some examples, control computer 52 determines an air volume flow rate based on a current water flow volume and one or more detected temperatures. For example, control computer 52 may receive a temperature from a temperature sensor 85 coupled to a glass forming roll 46. Control computer 52 may execute an algorithm that generates the airflow volume based on a current water flow (e.g., as currently configured by water flow control 75) and the detected temperature. The algorithm may be a machine learning algorithm trained with supervised data identifying temperatures, airflow volumes, and water flow volumes, for example. Control computer 52 may configure airflow control 65 such that an airflow in accordance with the determined air volume flow rate is provided to a passageway 81.

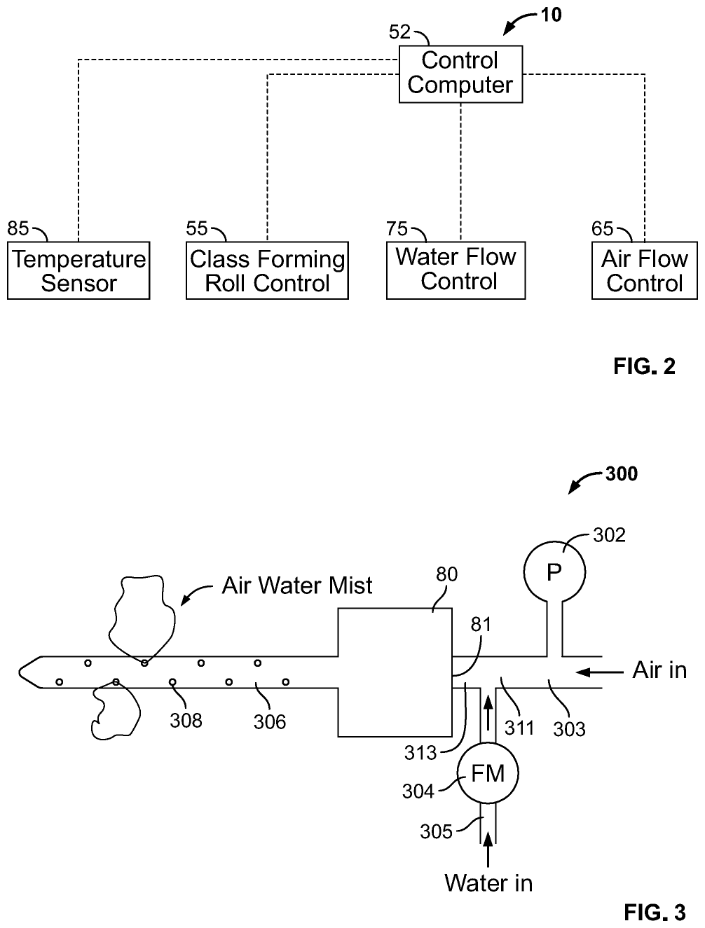

FIG. 3 illustrates exemplary portions of a glass forming roll cooling system 300 that may be employed in the glass forming apparatus 20 of FIG. 1. As illustrated, rotary joint 80 includes a passageway 81 through which a mixture of air and water proceeds. For example, air may be provided (e.g., via an air compressor) through an air passageway 303, and water may be provided through a water passageway 305. Each of air passageway 303 and water passageway 305 may be tubes, hoses, pipes, or any other suitable passageways. The water passageway 305 provides water (e.g., from a water pump), which is then mixed with air proceeding through the air passageway 303 at a passageway junction 311 to form an air-water mixture. For example, passageway junction 311 may be a three way tubular junction that couples to air passageway 303 via a first inlet, and to water passageway 305 via a second inlet. After mixing at passageway junction 311, the air-water mixture proceeds through air-water mixture passageway 313 to passageway 81 of rotary joint 80.

In some examples, airflow control 65 regulates the air volume flow rate provided via air passageway 303, and water flow control 75 regulates the water volume flow rate provided via water passageway 305. For example, airflow control 65 may a control unit of an air compressor that provides airflow to air passageway 303. Water flow control 75 may be a control unit of a water supply, such as a water pump, that provides water through water passageway 305.

Control computer 52 may control the air volume flow rate provided through air passageway 303 by communicating with airflow control 65, and may control the water volume flow rate provided through water passageway 305 by communicating with water flow control 75.

Further, glass forming roll cooling system 300 includes an air pressure gauge 302 operatively coupled to air passageway 303, and a flow meter 304 operatively coupled to water passageway 305. Air pressure gauge 302 can measure an air pressure within air passageway 303, and flow meter 304 can measure the flow of water through water passageway 305. Control computer 52 may be communicatively coupled to each of air pressure gauge 302 and flow meter 304. In some examples, air pressure gauge 302 is a subunit of airflow control 65, and flow meter 304 is a subunit of water flow control 75.

For example, control computer 52 may provide a signal to air pressure gauge 302 and, in response, receive from air pressure gauge 302 an air pressure reading (e.g., data identifying an air pressure within air passageway 303). control computer 52 may provide a signal to air pressure gauge 302 and, in response, Similarly, control computer 52 may provide a signal to flow meter 304 and, in response, receive from flow meter 304 an water flow reading (e.g., data identifying a water flow rate within water passageway 305).

After mixing at passageway junction 311, the air-water mixture proceeds through air-water mixture passageway 313 to passageway 81. The air-water mixture then proceeds through passageway 81 and reaches a conduit 306 that includes a plurality of openings 308. In some examples, the conduit is a nozzle, such as a spray nozzle. The plurality of openings 308 allows the air-water mixture to disperse (e.g., as an air-water mist) within a cavity of a glass forming roll 46. In some examples, each of the plurality of openings 308 are spaced equidistantly from each other. In some examples, the plurality of openings are spaced apart to disperse the air-water mixture evenly within the cavity of the glass forming roll 46.

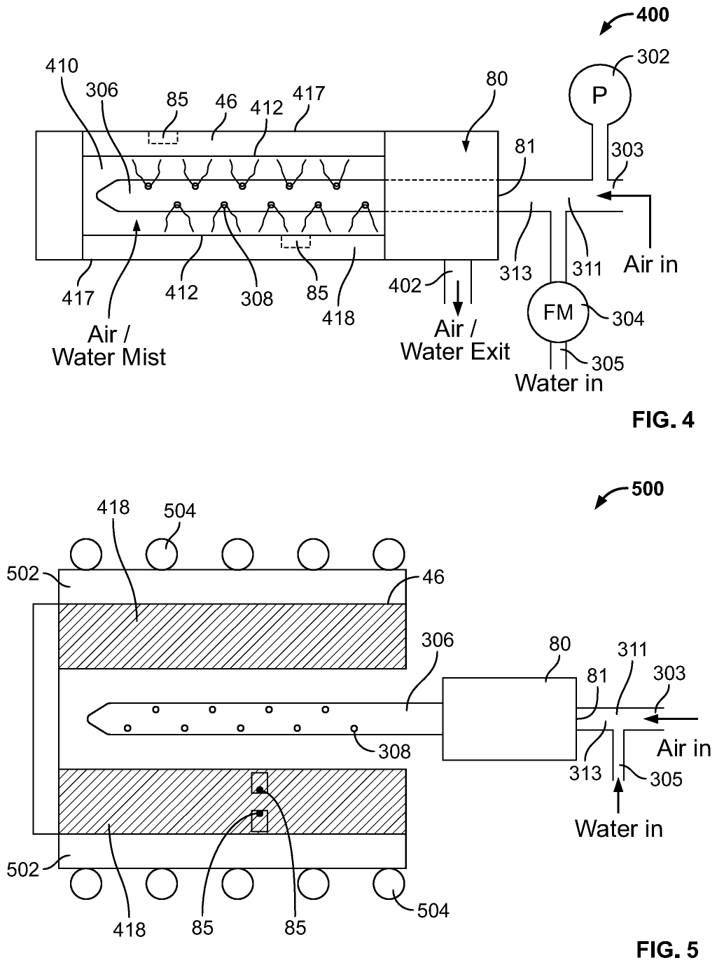

FIG. 4 illustrates an exemplary glass forming roll cooling system 400 with a conduit 306 within an inner cavity 410 of a glass forming roll 46. In addition, glass forming roll cooling system 400 includes an exit passageway 402 that allows an exit passageway for the air-water mixture to exit the inner cavity 410 of the glass forming roll 46.

For example, as the air-water mixture is dispersed via the plurality of openings 308 of conduit 306, the air-water mixture may contact inside surfaces 412 of the glass forming roll 46. The inside surfaces 412 may form the inner cavity 410. The air-water mixture may dissipate heat from the inside surfaces 412. As additional air-water mixture is provided within the inner cavity 410, a pressure within the inner cavity may increase. The increased pressure may cause air-water mixture to exit via the exit passageway 402. In some examples, a pump pumps the air-water mixture out of the inner cavity 410. For example, control computer 52 may provide signals to the pump to control the pumping of the air-mixture from the inner cavity 410. For example, control computer 52 may increase, or decrease the rate of pumping.

In some examples, glass forming roll cooling system 400 includes one or more temperature sensors 85 which can detect a temperature of glass forming roll 46. In some examples, a temperature sensor 85 is positioned such that it can detect the temperature within inner cavity 410. For example, the temperature sensor 85 may be attached to an inside surface 412 of the glass forming roll 46. In some examples, a temperature sensor 85 is position such that it can detect temperature near an outside surface 417 of glass forming roll 46. For example, the temperature sensor 85 may be embedded within a wall 418 of the glass forming roll 46. Control computer 52 is communicatively coupled to each temperature sensor 85, and is operable to receive temperature readings from the temperature sensors.

FIG. 5 illustrates glass forming roll cooling system test environment 500 that can be used to determine heat dissipation and extraction capabilities of various designs. The glass forming roll cooling system test environment 500 allows for a heating means that provides heat to an outside surface 417 of the glass forming roll 46. In this example, induction heating is employed. A plurality of inductor coils 504 provide heat through an insulation layer 502 to the outside surface 417 of the glass forming roll. A plurality of temperature sensors 85 detect temperature at various distances from the conduit 306. For example, one temperature sensor 85 may detect temperatures closer to an inside surface 412 of the glass forming roll 46, and another temperature sensor may detect temperatures closer to the outside surface 417 of the glass forming roll 46. Based on a temperature differences between temperatures detected at various locations, heat flux (e.g., heat dissipation) may be measured.

For example, control computer 52 may receive a first temperature from a temperature sensor 85 that measures the temperature near the inside surface 412 of the glass forming roll, and may also receive a second temperature from another temperature sensor 85 that measures the temperature near the outside surface 417 of the glass forming roll 46. Control computer 52 may determine the difference between the two, and may determine an amount of heat dissipation based on the difference. For example, control computer 52 may execute an algorithm to determine the heat dissipation as is known in the art.

As an example, assume control computer 52 causes an air compressor to provide an air at a first air volume flow rate via the air passageway 303, and also causes a water pump to provide water at a first water volume flow rate via the water passageway 305. Control computer 52 may receive from a first temperature sensor 85 a first temperature value that identifies a temperature detected near the outside surface 417 of the glass forming roll 46. Control computer 52 may also receive from a second temperature sensor 85 a second temperature value that identifies a temperature detected near the inside surface 412 of the glass forming roll 46. Control computer 52 may then determine a first heat dissipation value based on the temperature difference between the second temperature value and the first temperature value.

Control computer 52 may then cause the water pump to provide water at a second water volume flow rate via the water passageway 305. The second water volume flow rate may be greater than the first water volume flow rate. After a period of time, control computer 52 may request and receive from the second temperature sensor 85 a third temperature value that identifies the temperature detected near the inside surface 412 of the glass forming roll 46. Control computer 52 may then determine a second heat dissipation value based on the temperature difference between the third temperature value and the first temperature value. Similarly, control computer 52 may cause the air compressor and water pump to provide varying flow rates of air and water, respectively, and determine the effects on heat dissipation.

Table 1 below illustrates various glass forming roll 46 configurations (e.g., single roll, or double rolls), corresponding air pressures and water flows, and measured heat extraction and heat transfer coefficients (HTC).

TABLE 1

| | Inlet air | Inlet water | Heat | |
|---|---|---|---|---|
| Roll | pressure | flow | extraction | HTC |
| Single roll | 2 | 0.16 | 54000 | 100 |
| Single roll | 2 | 0.32 | 163000 | 450 |
| Double rolls | 2 | 0.05 | 73000 | 150 |

Control computer 52 may store the heat dissipation values in non-volatile memory. In some examples, control computer 52 provides the heat dissipation values for display. In some examples, the stored heat dissipation values are used to train one or more machine leaning algorithms.

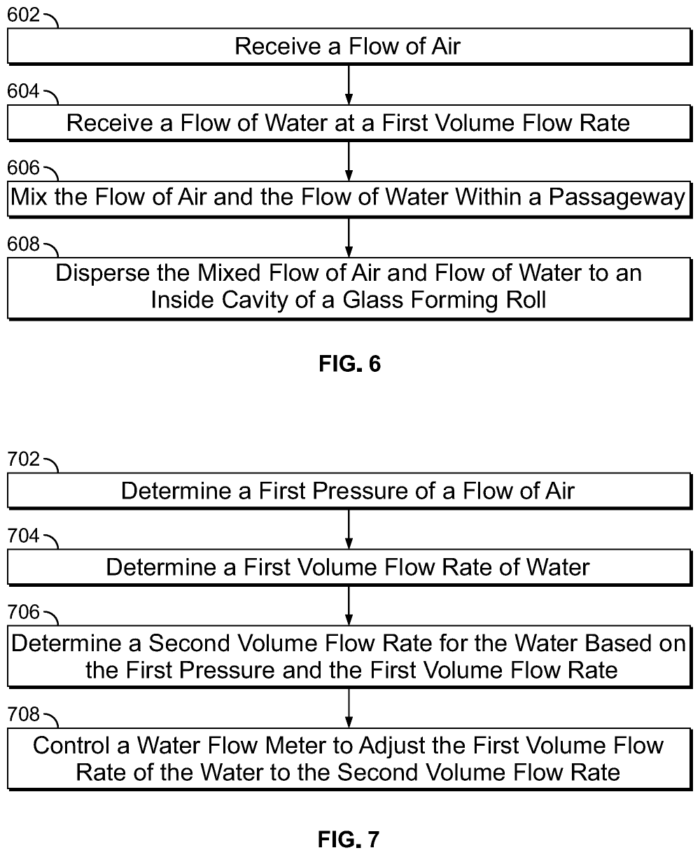

FIG. 6 illustrates an exemplary method that may be performed by a glass forming roll cooling system, such as glass forming roll cooling system 300 or glass forming roll cooling system 400. Beginning at step 602, a flow of air is received. For example, glass forming roll cooling system 300 may receive a flow of air via air passageway 303. At step 604, the glass forming roll cooling system 300 receives a flow of water at a first volume flow rate. For example, glass forming roll cooling system 300 may receive a flow of water via water passageway 305. The flow of water may be provide at a first volume flow rate. For example, control computer 52 may provide a signal to water flow control 75 to cause the flow of water at the first volume flow rate.

Proceeding to step 606, the flow of air and the flow of water are mixed within a passageway. For example, the flow of water via water passageway 305 and the flow of air via air passageway 303 may mix at junction 311. At step 608, the mixed flow of air and water is dispersed within a cavity of a glass forming roll. As an example, the mixed flow of air and water may be provided through a passageway 81 of a rotary joint 80 to a conduit 306 within a cavity 410 of a glass forming roll 46. The conduit 306 may include a plurality of openings 308 through which the air and water mixture disperses into the cavity 410 of the glass forming roll. The air and water mixture may contact an inside surface 412 of the glass forming roll 46, and may thereby dissipate heat from the glass forming roll 46. The method then ends.

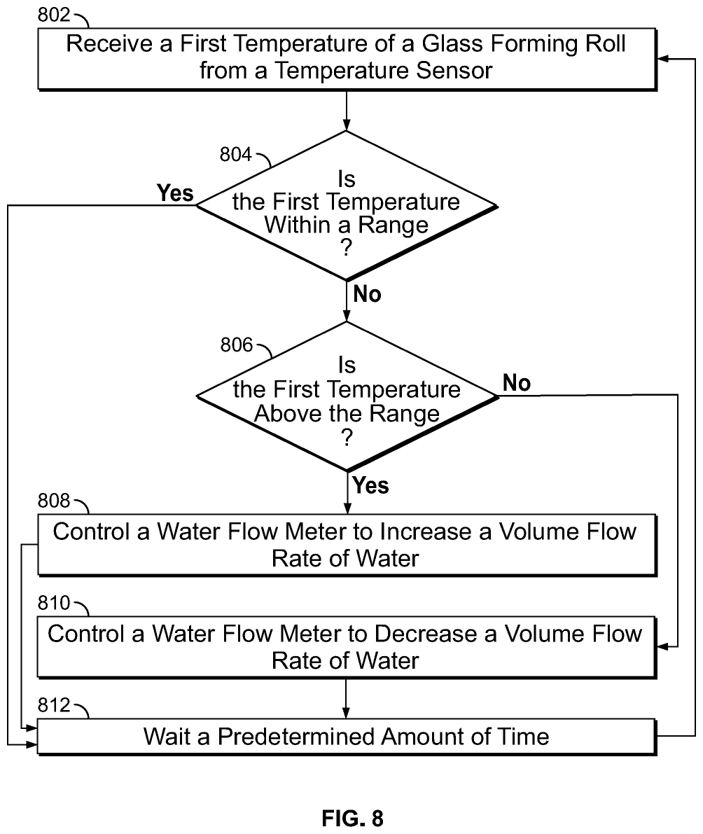

FIG. 7 illustrates an exemplary method that may be performed by one or more computing devices, such as control computer 52. The method may be performed to control heat dissipation from glass forming rolls 46 during the glass formation process. Beginning at step 702, the computing device determines a first pressure of a flow of air. For example, control computer 52 may request and receive from an air pressure gauge 302 a first pressure of a flow of air within an air passageway 303. At step 704, the computing device determines a first volume flow rate of water. For example, control computer 52 may request and receive from a flow meter 304 a first volume flow rate of water within a water passageway 305.

Proceeding to step 706, a second volume flow rate for the water is determined based on the first pressure and the first volume flow rate. For example, control computer 52 may determine, based on a table stored in memory, that the first volume flow rate of water within water passageway 305 (e.g., current volume flow rate of water within water passageway 305) should be adjusted (e.g., increased) to the second volume flow rate given the first pressure of the flow of air. In some examples, control computer 52 executes an algorithm, such as a machine learning algorithm, to determine the second volume flow rate based on the first pressure of the flow of are and the first volume flow rate of water. The method then ends.

FIG. 8 illustrates an exemplary method that may be performed by one or more computing devices, such as control computer 52. The method may be performed to control heat dissipation from glass forming rolls 46 during the glass formation process. Beginning at step 802, the computing device receives a first temperature of a glass forming roll from a temperature sensor. For example, control computer 52 may transmit a signal to a temperature sensor 85 that detects the temperature of a glass forming roll 46 in a glass forming apparatus 20. In response to transmitting the signal, the control computer 52 may receive temperature data identifying and characterizing a temperature of the glass forming roll 46 (e.g., a temperature as detected on an inside surface 412 of an inner cavity 410 of the glass forming roll 46). At step 804, the computing device determines whether the first temperature is within a range. For example, control computer 52 may obtain a temperature range from memory, and may determine whether the first temperature falls within the temperature range (e.g., inclusively). The temperature range may be a desired temperature range given the type of glass being manufactured. If the first temperature is within the range, the method proceeds to step 812. Otherwise, if the first temperature is not within the range, the method proceeds to step 806.

At step 806, the computing device determines whether the first temperature is above the range. If the first temperature is not above the range, the method proceeds to step 810. At step 810, the computing device controls a water flow meter to decrease a volume flow rate of water. For example, control computer 52 may transmit a signal to water flow control 75 to decrease a water volume flow rate being provided to water passageway 303. The method then proceeds to step 812.

If, back at step 806, the computing device determines that the first temperature is above the range, the method proceeds to step 808. At step 808, the computing device controls a water flow meter to increase a volume flow rate of water. For example, control computer 52 may transmit a signal to water flow control 75 to increase a water volume flow rate being provided to water passageway 303. The method then proceeds to step 812.

At step 812, the computing device waits a predetermined amount of time before proceeding back to step 802. For example, a user may provide a configuration setting for the amount of time to wait. The predetermined amount of time may be empirically determined, in some examples, and may correlate with an amount time needed to detect a temperature change after adjusting the volume flow rate of water.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of this disclosure. Modifications and adaptations to these embodiments will be apparent to those skilled in the art and may be made without departing from the scope or spirit of this disclosure.

What is claimed is:

1. An apparatus comprising:
a first passageway configured to provide a gas;
a second passageway in fluid communication with the first passageway and configured to provide a liquid;
a junction configured to mix the gas from the first passageway with the liquid from the second passageway to generate a gas-liquid mixture; and
a conduit in fluid communication with the junction and configured to disperse the gas-liquid mixture to a glass forming roll.

2. The apparatus of claim 1, wherein the nozzle is at least partially located within a cavity of the glass forming roll.

3. The apparatus of claim 2, wherein the nozzle comprises a plurality of openings.

4. The apparatus of claim 3, wherein the gas-liquid mixture is dispersed through the plurality of openings causing the gas-liquid mixture to contact an inside surface of the cavity of the glass forming roll.

5. The apparatus of claim 1, comprising a controller communicatively coupled to a temperature sensor, wherein the temperature sensor is configured to detect a temperature of the glass forming roll, and wherein the controller is configured to receive the temperature of the glass forming roll from the temperature sensor.

6. The apparatus of claim 5, comprising:
a gas flow control communicatively coupled to the controller and configured to adjust a flow of the gas within the first passageway; and
a liquid flow control communicatively coupled to the controller and configured to adjust a flow of the liquid within the second passageway, wherein the controller is configured to:
provide a first signal to the gas flow control to adjust the flow of the gas; and
provide a second signal to the liquid flow control to adjust the flow of the liquid.

7. The apparatus of claim 6, wherein providing the second signal to the liquid flow control comprises:
determining that the temperature of the glass forming roll is not within a temperature range, wherein the temperature range comprises a maximum temperature and a minimum temperature; and
for the condition where the temperature of the glass forming roll is above the maximum temperature, providing the second signal to the liquid flow control to increase the flow of the liquid; and
for the condition where the temperature of the glass forming roll is below the minimum temperature, providing the second signal to the liquid flow control to decrease the flow of the liquid.

8. The apparatus of claim 1, comprising:
a gas pressure gauge configured to measure a gas pressure of the gas in the first passageway; and
a liquid flow meter configured to measure a flow rate of the liquid in the second passageway.

9. The apparatus of claim 8, comprising a controller communicatively coupled to the gas pressure gauge and the flow meter, wherein the controller is configured to:
receive, from the gas pressure gauge, first data identifying the gas pressure of the gas in the first passage way; and
receive, from the flow meter, second data identifying the flow rate of the liquid in the second passageway.

10. An apparatus comprising:
a memory device storing instructions; and
a controller comprising at least one processor communicatively coupled to the memory device and configured to execute the instructions, causing the controller to:
transmit a first signal to cause a flow of air at a first air volume flow rate within a first passageway; and
transmit a second signal to cause a flow of water at a first water volume flow rate within a second passageway, wherein the flow of air is mixed with the flow of water at a junction to form an air-water mixture, and wherein the air-water mixture is dispersed to cool a glass forming roll.

11. The apparatus of claim 10, wherein the controller is configured to:
receive a temperature from a temperature sensor configured to detect temperatures of the glass forming roll; and
adjust the flow of water to be at a second water volume flow rate based on the temperature.

12. The apparatus of claim 11, wherein adjusting the flow of water comprises:
determining that the temperature is outside a temperature range; and
increasing the flow of water to be at the second water volume flow rate based on the determination.

13. The apparatus of claim 12, wherein adjusting the flow of water comprises determining the second water volume flow rate from a look-up table stored in said memory device, wherein the look up table associates each of a plurality of temperature ranges with a water volume flow rate range.

14. The apparatus of claim 13, wherein adjusting the flow of water comprises executing a machine learning algorithm to determine the second water volume flow rate.

15. The apparatus of claim 10, wherein the controller is configured to receive, from an air pressure gauge, a first pressure of air within the first passageway, wherein causing the flow of water at the first water volume flow rate is based on the first pressure of air.

16. The apparatus of claim 10, wherein the controller is configured to receive, from a flow meter, the first water volume flow rate.

17. A method of cooling a glass forming roll comprising:
flowing air through a first passageway;
flowing water through a second passageway in fluid communication with the first passageway;
mixing the air from the first passageway with the water from the second passageway at a junction to form an air-water mixture;
dispersing the air-water mixture to a glass forming roll.

18. The method of claim 17, further comprising drawing molten glass with the glass forming roll from a forming apparatus, wherein the dispersing the air-water mixture is performed during the drawing of the molten glass.

19. The method of claim 17, comprising:
receiving a temperature of the glass forming roll; and
adjusting a flow rate of the water flowing through the second passageway based on the temperature.

20. The method of claim 17, comprising:
receiving a temperature of the glass forming roll; and
adjusting a flow rate of the air flowing through the first passageway based on the temperature.
